(19) United States
(12) Patent Application Publication
(10) Pub. No.: US 2025/0233542 A1
(43) Pub. Date: Jul. 17, 2025

(54) WIND AND WAVE REDUCTION DEVICE FOR AN OFFSHORE SOLAR PHOTOVOLTAIC MODULE AND WIND AND WAVE REDUCTION SYSTEM INCLUDING THE SAME

(71) Applicant: SUN RISE E&T CORPORATION, Pingtung City (TW)

(72) Inventor: Chi-Hsu TUNG, Pingtung City (TW)

(21) Appl. No.: 19/011,757

(22) Filed: Jan. 7, 2025

(30) Foreign Application Priority Data
Jan. 17, 2024 (TW) 113101900

(51) Int. Cl. H02S 20/00; B63B 17/00; B63B 35/44

(52) U.S. Cl. CPC H02S 20/00; B63B 2017/0045; B63B 2035/4453

(57) ABSTRACT

A wind and wave reduction device includes base seats and base pipes. Each base seat has two lateral ends and through holes disposed between the lateral ends. Each base pipe extends through a respective one of the through holes of each of the base seats. Step plates are disposed on support frames, and each of the support frames is positioned between two adjacent ones of the base pipes. A lateral frame is connected transversely to one of the lateral ends of each of the base seats. A blocking plate is fixed to the lateral frame and has air disturbing holes.

### CROSS-REFERENCE TO RELATED APPLICATION

This application claims priority to Taiwanese Invention Patent Application No. 113101900, filed on Jan. 17, 2024, the entire disclosure of which is incorporated by reference herein.

### FIELD

The disclosure relates to an offshore solar photovoltaic auxiliary device, and more particularly to a wind and wave reduction device for offshore solar photovoltaic module and a wind and wave reduction system including the same.

### BACKGROUND

In comparison with a solar power generation device disposed on land, an offshore solar photovoltaic device is disposed on a sea surface distant from the land. As a result, the offshore solar photovoltaic device may avoid exploiting the land, and may also receive sufficient sunlight to effectively generate electricity.

The offshore solar photovoltaic device is positioned away from the land to prevent offshore activities near the land from being adversely affected and to benefit from maximum sunlight. In open sea, waves and winds may be relatively strong. Although the offshore solar photovoltaic device is relatively large in size and may generate greater power, the strong winds and waves may damage the offshore solar photovoltaic device. When the offshore solar photovoltaic device is damaged, maintenance cost of the offshore solar photovoltaic device is high, and the offshore solar photovoltaic device may not be able to generate an expected amount of power.

### SUMMARY

Therefore, one object of the disclosure is to provide a wind and wave reduction device for an offshore solar photovoltaic module that can alleviate at least one of the drawbacks of the prior art.

According to one object of the disclosure, a wind and wave reduction device includes a base unit and a protective unit.

The base unit includes a plurality of base seats, a plurality of base pipes, a plurality of support frames, and a plurality of step plates. The plurality of base seats are spaced apart from each other in a first direction. Each of the plurality of base seats has two lateral ends that are opposite to each other in a second direction perpendicular to the first direction, and a plurality of through holes that are disposed between the lateral ends, that extend through the base seat in the first direction, and that are spaced apart from each other in the second direction. Each of the plurality of base pipes extends through a respective one of the plurality of through holes of each of the plurality of base seats. Each of the plurality of support frames is positioned between two adjacent ones of the plurality of base pipes. The plurality of step plates are disposed on the plurality of support frames.

The protective unit is connected to the base unit, and includes a lateral frame and at least one blocking plate. The lateral frame is connected transversely to one of the lateral ends of each of the plurality of base seats. The at least one blocking plate is fixed to the lateral frame and has a plurality of air disturbing holes penetrating therethrough in the second direction.

According to another object of the disclosure, a wind and wave reduction system is provided, and includes a plurality of the aforesaid wind and wave reduction devices and a plurality of connecting modules.

Each of the plurality of connecting modules includes a connecting member interconnecting the lateral frames of two respective adjacent ones of the plurality of wind and wave reduction devices such that the plurality of wind and wave reduction devices are connected to each other and cooperatively define an inner field.

The at least one blocking plate of each of the plurality of wind and wave reduction devices is adjacent to the inner filed.

The plurality of base pipes of each of the plurality of wind and wave reduction devices are spaced apart from each other in a direction away from the inner field.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a wind and wave reduction device according to an embodiment of the disclosure.

FIG. 2 is a top view illustrating a wind and wave reduction system including wind and wave reduction devices of the embodiment for placement of offshore solar photovoltaic modules.

FIG. 3 is a schematic side view of the embodiment illustrating a base unit and a protective unit of the wind and wave reduction device.

FIG. 4 is a perspective view of the embodiment illustrating base seats and base pipes to reduce waves.

FIG. 5 is a perspective view of the embodiment illustrating the wind and wave reduction system.

FIG. 6 is a top view of the embodiment illustrating a bent pipe of the wind and wave reduction system.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

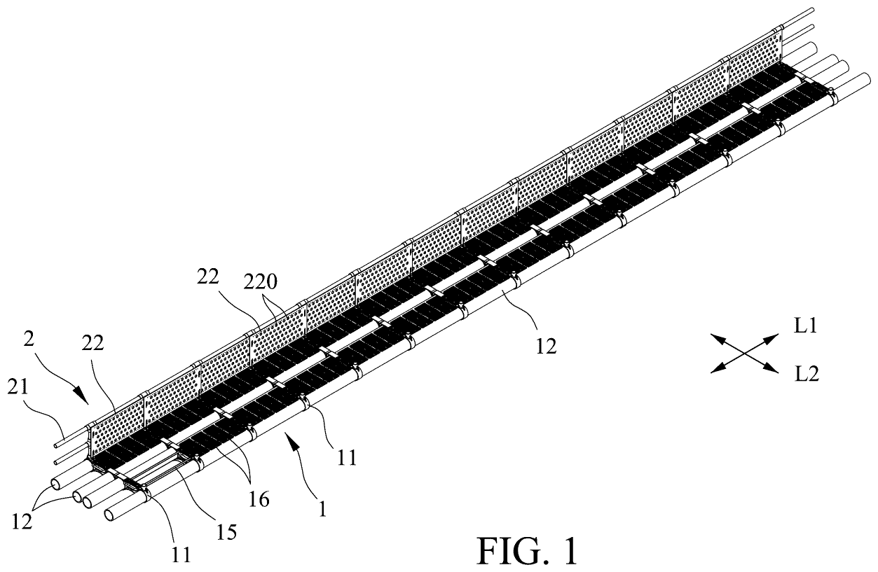

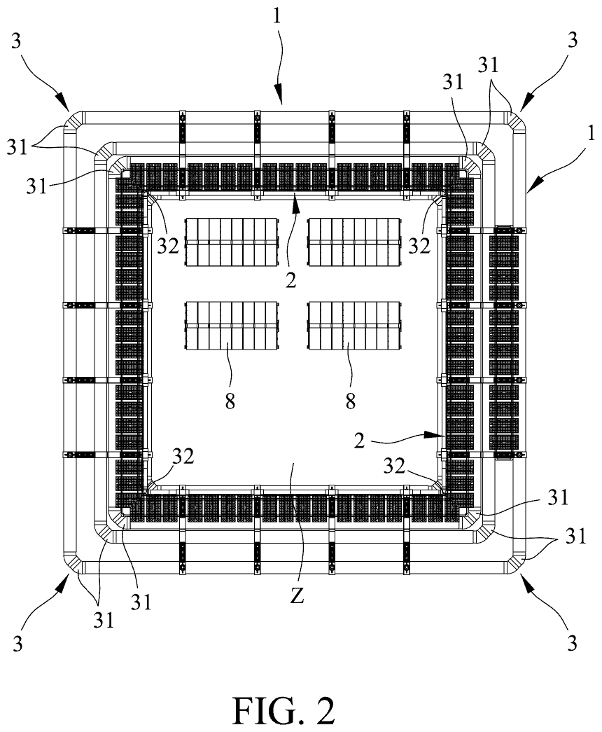

Referring to FIG. 1, a wind and wave reduction device according to an embodiment of the disclosure includes a base unit 1 and a protective unit 2 connected to the base unit 1. As shown in FIG. 2, a wind and wave reduction system of the disclosure includes a plurality of the wind and wave reduction devices disposed on a sea surface for placement of a plurality of offshore solar photovoltaic modules 8 that are arranged in a spaced-apart manner on the sea surface. As shown in FIG. 2, the number of the wind and wave reduction devices is four. Accordingly, an inner filed (Z) is established by the wind and wave reduction devices for the placement of the offshore solar photovoltaic modules 8 so that the offshore solar photovoltaic modules 8 are likely to be protected in all directions by the wind and wave reduction devices. Furthermore, based on actual requirements, the wind and wave reduction system of the disclosure is adjustable in dimension.

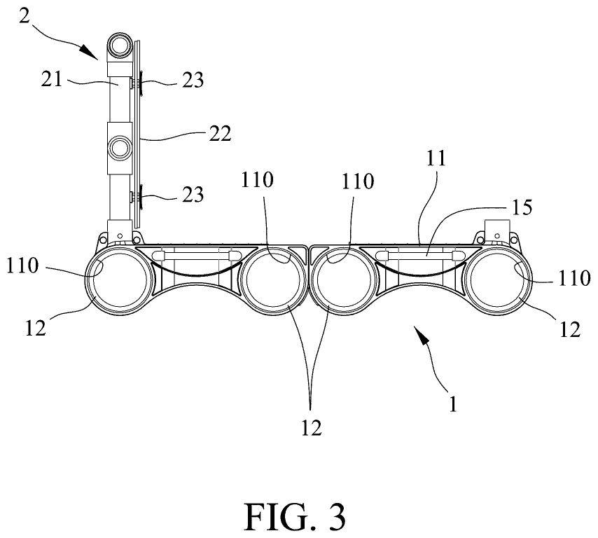

Referring to FIGS. 1 and 3, the base unit 1 includes a plurality of base seats 11, a plurality of base pipes 12, a plurality of support frames 15, and a plurality of step plates 16. The base seats 11 are spaced apart from each other in a first direction (L1). Each of the base seats 11 has two lateral ends that are opposite to each other in a second direction (L2) perpendicular to the first direction (L1), and a plurality of through holes 110 that are disposed between the lateral ends, that extend through the base seat 11 in the first direction (L1), and that are spaced apart from each other in the second direction (L2). Each of the base pipes 12 extends through a respective one of the through holes 110 of each of the base seats 11. Each of the support frames 15 is positioned between two adjacent ones of the base pipes 12. The step plates 16 are disposed on the support frames 15 so that an operator may walk on the step plates 16 for maintenance. Specifically, the base seat 11 is made from a rigid material. Based on a dimensional requirement of the wind and wave reduction system of the disclosure, each of the base pipes 12 may vary in length based on selection. The base seats 11 and the base pipes 12 cooperatively form a main structure.

As shown in FIGS. 1 and 3, the protective unit 2 includes a lateral frame 21, a plurality of blocking plates 22, and a plurality of hanging members 23. The lateral frame 21 is connected transversely to one of the lateral ends of each of the base seats 11. The blocking plates 22 are fixed to the lateral frame 21. The hanging members 23 fix the blocking plates 22 onto the lateral frame 21. Each of the blocking plates 22 is a hardness plate, and has a plurality of air disturbing holes 220 penetrating therethrough in the second direction (L2).

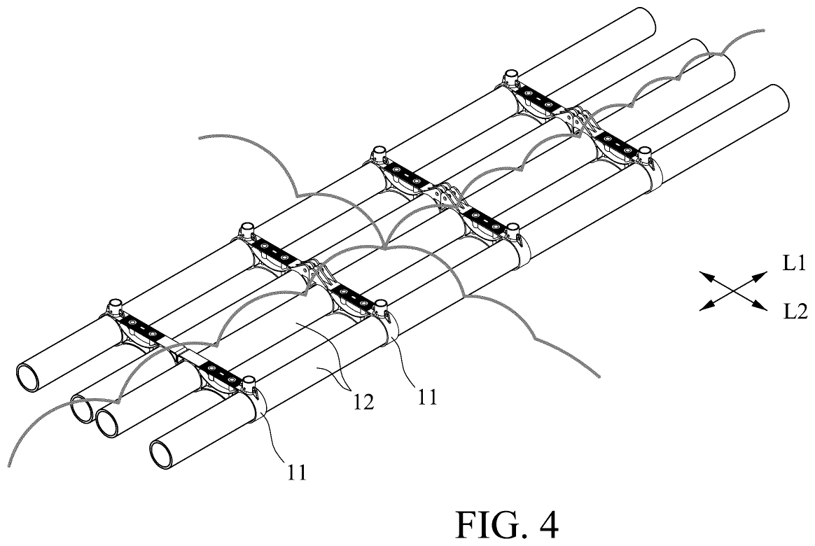

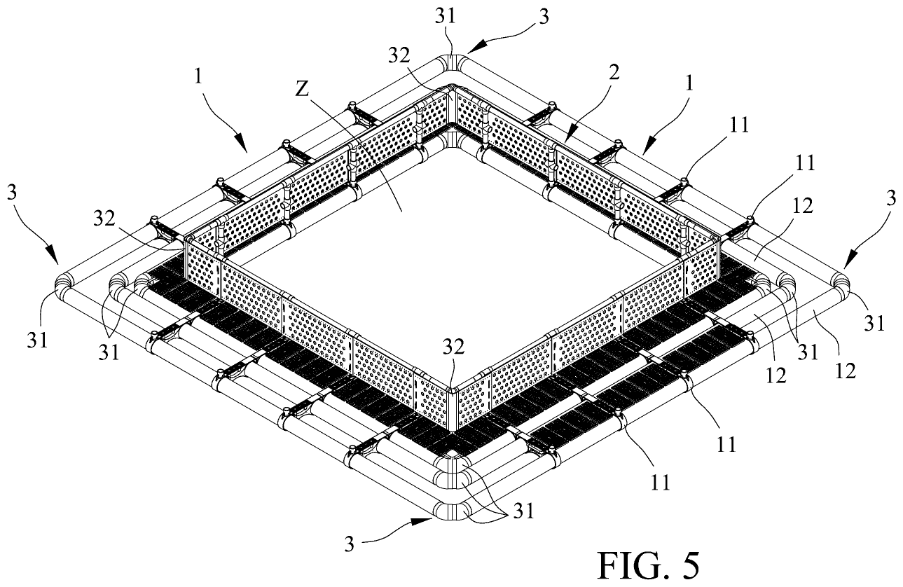

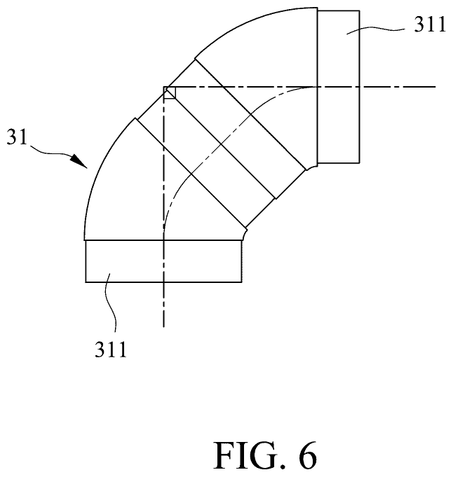

Referring to FIGS. 4 and 5 in combination with FIG. 1, to place the wind and wave reduction system of the disclosure on the sea surface at a distance away from a shore, the wind and wave reduction devices are first assembled to each other on the shore. As shown in FIG. 5, the wind and wave reduction system of the disclosure includes the four wind and wave reduction devices, and four connecting modules 3. Each of the connecting modules 3 includes four bent pipes 31 and a connecting member 32. For each of the connecting modules 3, each of the bent pipes 31 interconnects a respective one of the base pipes 12 of one of two respective adjacent ones of the wind and wave reduction devices and a respective one of the base pipes 12 of the other one of the respective adjacent ones of the wind and wave reduction devices. For each of the connecting modules 3, the connecting member 32 interconnects the lateral frames 21 of two respective adjacent ones of the wind and wave reduction devices such that the wind and wave reduction devices are connected to each other and cooperatively define the inner field (Z). In this embodiment, as shown in FIG. 6, each of the bent pipes 31 has two extension portions 311 that are integrally connected to each other. For each of the bent pipes 31, each of the extension portions 311 extends along an extension line, and the extension lines of the extension portions 311 are perpendicular to each other. Furthermore, the blocking plates 22 of each of the wind and wave reduction devices is adjacent to the inner filed (Z). The base pipes 12 of each of the wind and wave reduction devices are spaced apart from each other in a direction away from the inner field (Z).

After assembly of the wind and wave reduction system is completed, the wind and wave reduction system is moved to a predetermined offshore location, and is anchored and positioned at the predetermined offshore location while the offshore solar photovoltaic modules 8 are placed in the inner field (Z). Because the connecting member 32 of each of the connecting modules 3 interconnects the lateral frames 21 of two respective adjacent ones of the wind and wave reduction devices, the blocking plates 22 stably enclose the inner field (Z). As a result, the blocking plates 22 may shield the inner field (Z) from strong offshore winds in all directions so as to protect the offshore solar photovoltaic modules 8 in the inner filed (Z). Furthermore, the air disturbing holes 220 of the blocking plates 22 are likely to disturb airflow, thereby reducing the winds. As shown in FIGS. 3 and 4, because the base seats 11 are spaced apart from each other in the first direction (L1), because the through holes 110 of each of the base seats 11 are spaced apart from each other in the second direction (L2), and because each of the base pipes 12 extends through the respective one of the through holes 110 of each of the base seats 11, the base seats 11 are likely to impede waves in the first direction (L1) so as to diminish strengths of the waves sequentially passing the base seats 11 in the first direction (L1), and the base pipes 12 are likely to impede waves in the second direction (L2) so as to diminish strengths of the waves sequentially passing the base pipes 12 in the second direction (L2). Accordingly, when waves in all directions move toward the wind and wave reduction system of the disclosure, the waves in all directions are likely to be effectively reduced by the base units 1 of the wind and wave reduction devices, thereby reducing adverse effects on the stability of the wind and wave reduction system.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A wind and wave reduction device for an offshore solar photovoltaic module, said wind and wave reduction device comprising:
a base unit including
a plurality of base seats that are spaced apart from each other in a first direction, each of said plurality of base seats having two lateral ends that are opposite to each other in a second direction perpendicular to the first direction, and a plurality of through holes that are disposed between said lateral ends, that extend through said base seat in the first direction, and that are spaced apart from each other in the second direction,
a plurality of base pipes, each of said base pipes extending through a respective one of said plurality of through holes of each of said plurality of base seats,
a plurality of support frames, each of said plurality of support frames being positioned between two adjacent ones of said plurality of base pipes, and
a plurality of step plates that are disposed on said plurality of support frames; and
a protective unit connected to said base unit, and including
a lateral frame that is connected transversely to one of said lateral ends of each of said plurality of base seats, and
at least one blocking plate that is fixed to said lateral frame and that has a plurality of air disturbing holes penetrating therethrough in the second direction.

2. The wind and wave reduction device as claimed in claim 1, wherein said protective unit further includes at least one hanging member that fixes said at least one blocking plate onto said lateral frame.

3. A wind and wave reduction system comprising:
a plurality of said wind and wave reduction devices as claimed in claim 1; and
a plurality of connecting modules, each of said plurality of connecting modules including a connecting member interconnecting said lateral frames of two respective adjacent ones of said plurality of wind and wave reduction devices such that said plurality of wind and wave reduction devices are connected to each other and cooperatively define an inner field; and
wherein said at least one blocking plate of each of said plurality of wind and wave reduction devices is adjacent to said inner filed; and
wherein said plurality of base pipes of each of said plurality of wind and wave reduction devices are spaced apart from each other in a direction away from said inner field.

4. The wind and wave reduction system as claimed in claim 3, wherein each of said plurality of connecting modules further includes a plurality of bent pipes, each of said plurality of bent pipes interconnecting a respective one of said plurality of base pipes of one of the respective adjacent ones of said plurality of wind and wave reduction devices and a respective one of said plurality of base pipes of another one of the respective adjacent ones of said plurality of wind and wave reduction devices.

5. The wind and wave reduction system as claimed in claim 4, wherein:
each of said plurality of bent pipes has two extension portions that are integrally connected to each other; and
for each of said plurality of bent pipes, each of said extension portions extends along an extension line, and the extension lines of said extension portions are perpendicular to each other.
